(19) United States
(12) Patent Application Publication
(10) Pub. No.: US 2016/0253930 A1
(43) Pub. Date: Sep. 1, 2016

(54) MULTI-VISION AND METHOD OF CONTROLLING THE SAME

(71) Applicant: LG ELECTRONICS INC., Seoul (KR)

(72) Inventor: Kwangryul LEE, Seoul (KR)

(73) Assignee: LG ELECTRONICS INC., Seoul (KR)

(21) Appl. No.: 15/031,400

(22) PCT Filed: Aug. 28, 2014
(86) PCT No.: PCT/KR2014/008035

§ 371 Date: Apr. 22, 2016

(30) Foreign Application Priority Data
Oct. 24, 2013 (KR) 10-2013-0127274

(51) Int. Cl. G09F 9/302; G09G 5/38; G06F 3/14

(52) U.S. Cl. CPC G09F 9/3026; G06F 3/1446; G09G 5/38; G09G 2300/026; G09G 2340/0464

(57) ABSTRACT

A multi-vision display including a plurality of displays including a master display and slave displays in a matrix form; and a controller configured to display image portions on the plurality of displays to form a display image, and shift the image portions on the plurality of displays in a synchronized manner a predetermined number of times to perform an orbit function and prevent a residual image on the plurality of displays.

### TECHNICAL FIELD

The present invention relates to a multi-vision and a method of controlling the same and, more particularly, to a multi-vision and a method of controlling the same, which are capable of preventing the distortion of an image attributable to the execution of an orbit function.

### BACKGROUND ART

A multi-vision may be configured in a form in which a plurality of independent displays is arranged. The displays may partially display different images, may display the same image, or may display images in a puzzle form.

In the past, a CRT type was used as the displays for the multi-vision, but in recent years, a PDP, LCD, and/or LED type is gradually used as the displays for the multi-vision.

Various problems attributable to the characteristic of a multi-vision in which a plurality of displays is combined with respect to the edit, transmission, and/or control of an image need to be solved.

### DISCLOSURE OF INVENTION

### Technical Problem

The present invention provides a multi-vision and a method of controlling the same, which are capable of preventing the distortion of an image attributable to the execution of an orbit function.

### Solution to Problem

In an aspect, there is provided a multi-vision. The multi-vision includes a frame and a plurality of displays configured to neighbor one another in a matrix form through the frame. The plurality of displays may include a control unit configured to perform an orbit function for moving an image displayed on the plurality of displays in order to prevent a residual image on the plurality of displays and to control the position of the image in response to a control signal received from at least one master display of the plurality of displays.

The master display may be configured to generate the control signal in a predetermined first cycle at a specific interval.

The first cycle may be longer than a second cycle in which the orbit function is executed.

The plurality of displays may be further configured to measure whether or not the second cycle has been reached based on timers embedded in the plurality of respective displays.

The control signal may include information about at least one of a point of time at which the position of the image is to be controlled, the position to which the image is to move, and the direction along which the image is to move.

The control signal may include a signal-in that enables the image to move to the reference positions of the plurality of respective displays.

The control unit displays that the control signal has not been received if the control signal is not received for a predetermined time or higher.

The multi-vision may further include signal lines configured to sequentially transfer the control signal from the master display to other displays.

The master display may include at least one display that belongs to the plurality of displays and that is present on the signal lines.

The display may include a wireless communication unit configured to send and receive the control signals.

In another aspect, there is provided a method of controlling a multi-vision. The method includes performing an orbit function for moving a displayed image in order to prevent a residual image on a plurality of displays configured to neighbor one another, receiving a control signal from at least one master display of the plurality of displays, and changing the position of the image in response to the control signal.

The control signal may be generated in a predetermined first cycle at a specific interval, and the first cycle may be longer than a second cycle in which the orbit function is performed.

Performing an orbit function may include measuring whether or not the second cycle has been reached based on timers embedded in the plurality of respective displays.

The control signal may include information about at least one of a point of time at which the position of the image is to be controlled, the position to which the image is to move, and the direction along which the image is to move.

The control signal may include a signal-in that enables the image to move to the reference positions of the plurality of respective displays.

The method may further include displaying that the control signal has not been received if the control signal is not received for a predetermined time or higher.

### Advantageous Effects of Invention

The multi-vision and the method of controlling the same according to embodiments of the present invention are advantageous in that the distortion of an image attributable to the execution of an orbit function can be prevented.

### BRIEF DESCRIPTION OF DRAWINGS

FIG. 1 is a diagram illustrating a multi-vision according to an embodiment of the present invention;

FIG. 2 is a diagram illustrating various configurations of the multi-vision of FIG. 1;

FIG. 3 is a diagram illustrating the wires of the multi-vision of FIG. 1;

FIGS. 4 to 6 are diagrams illustrating the orbit operation of a display;

FIGS. 7 to 9 are diagrams illustrating an example of the orbit operation of the multi-vision;

FIG. 10 is a flowchart illustrating an operational process of the multi-vision of FIG. 1;

FIGS. 11 and 12 are diagrams illustrating a process of setting the master display of the multi-vision in the operational process of FIG. 10;

FIGS. 13 to 15 are diagrams illustrating an operational process of the multi-vision in FIG. 10;

FIG. 16 is a diagram illustrating an operation of the multi-vision according to another embodiment of the present invention;

FIG. 17 is a flowchart illustrating an operational process of the multi-vision according to yet another embodiment of the present invention; and

FIG. 18 is a diagram illustrating an operation of the multi-vision according to yet another embodiment of the present invention.

### MODE FOR THE INVENTION

The above object, characteristics, and merits of the present invention will become more apparent from the following detailed description taken in conjunction with the accompanying drawings. However, the present invention may be modified in various ways, and may have several embodiments. Accordingly, only specific embodiments are illustrated in the drawings and are described in detail. In principle, the same reference numerals denote the same elements throughout the drawings. Furthermore, detailed descriptions of the known functions or constructions are omitted if they are deemed to make the gist of the present invention unnecessarily vague. Furthermore, numbers (e.g., the first and the second) used in the description of this specification are merely identification symbols for differentiating one element from another element.

A multi-vision related to an embodiment of the present invention is described in detail below with reference to the accompanying drawings. In the following description, suffixes “module” and “unit” may be given to components of the electronic device with consideration taken of only facilitation of description, and do not have meanings or functions discriminated from each other.

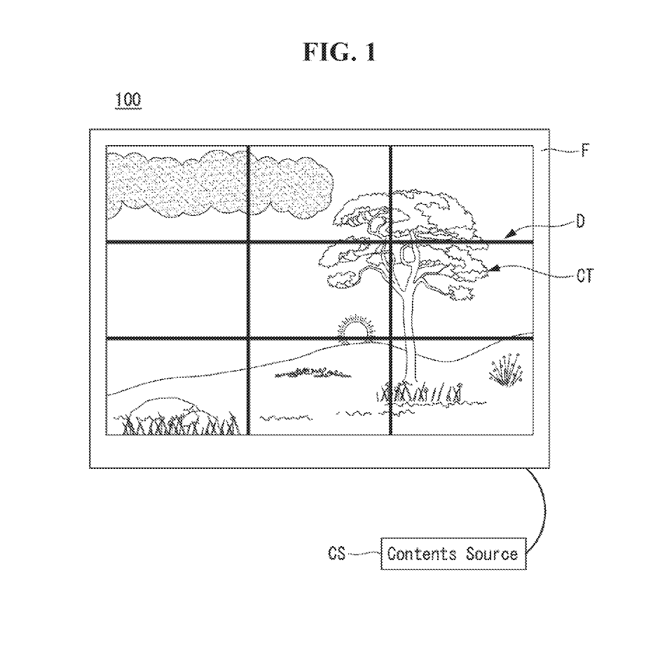

FIG. 1 is a diagram illustrating a multi-vision according to an embodiment of the present invention.

As illustrated in FIG. 1, the multi-vision 100 according to an embodiment of the present invention may include a plurality of displays D.

The plurality of displays D may be configured to neighbor one another in a matrix form. That is, this means that the plurality of displays D configured to perform independent functions is disposed. The plurality of displays D may be fixed by a frame F.

The frame F may function to fix the plurality of displays D. Furthermore, the frame F may include the bezel parts of the displays D. That is, the bezel part may mean an area between the display regions of the plurality of displays D. In order to increase the degree of immersion on an image displayed on the multi-vision 100, the thickness of the bezel gradually becomes thin.

The displays D may display specific content CT. For example, this means that the content CT received from a content source CS may be displayed on the displays D. The content source CS may be public wave and terrestrial wave broadcasting, CCTV, a PC, a set-top box, or a video telephony device. The content CT may be displayed on the displays D in various forms.

For example, in which the content CT is displayed, a piece of the content CT may be split and displayed in the plurality of displays D. That is, this means that the content CT is spit by the number of displays D and the split images are displayed on the respective displays D. If the content CT is displayed like this, the size of the content CT is increased by the size of the collected displays D. Accordingly, the content CT can be effectively transferred in a wide place where a number of persons gathered.

For another example, in which the content CT is displayed, different pieces of the content CT may be displayed on one part and the other part of the collected displays D. For example, this means that the broadcasting screen of a channel A may be displayed on one part of the displays D and the broadcasting screen of a channel B may be displayed on the remaining part of the displays D. The preference of a plurality of persons can be satisfied because different images are displayed on one part and the other part of the collected displays D.

For yet another example, in which the content CT is displayed, the content CT may be displayed on each of the displays D. That is, this means that the same content CT may be displayed on each of the displays D. If the same content CT is displayed on each of the displays D, the concentrativeness of the public can be increased.

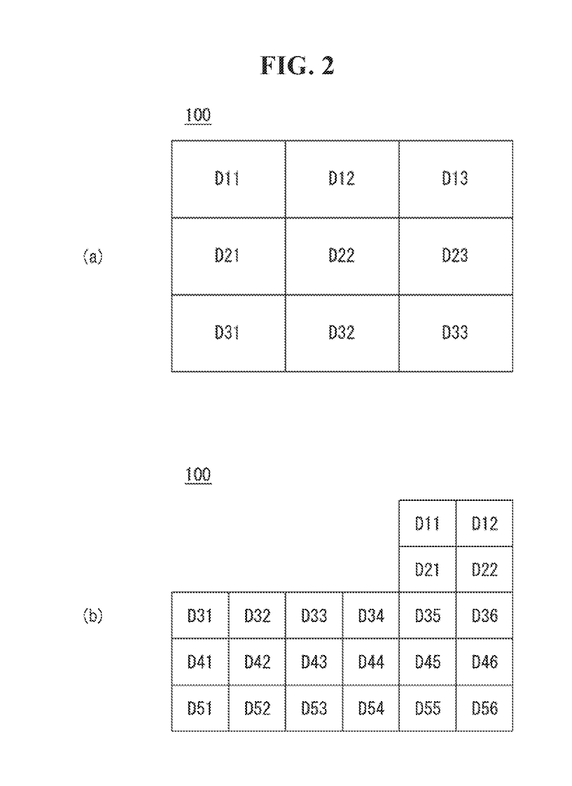

FIG. 2 is a diagram illustrating various configurations of the multi-vision of FIG. 1.

As illustrated in FIG. 2, the multi-vision 100 according to an embodiment of the present invention may be configured to neighbor one another in a matrix form.

As illustrated in FIG. 2(a), the multi-vision 100 may be disposed in a square form. For example, this means that the displays D may be disposed, for example, in a 3*3, 4*4, or 5*5 form. The display D is hereinafter indicated by D11, for example, depending on its position, for convenience of understanding. For example, the displays D at the top are indicated by D11 to D13, the displays D in the middle are indicated by D21 to D23, and the displays D at the bottom are indicated by D31 to D33.

As illustrated in FIG. 2(b), the multi-vision 100 may be disposed in forms other than a square. For example, this means that a set of D11 to D22 and a set of D31 to D56 may be combined.

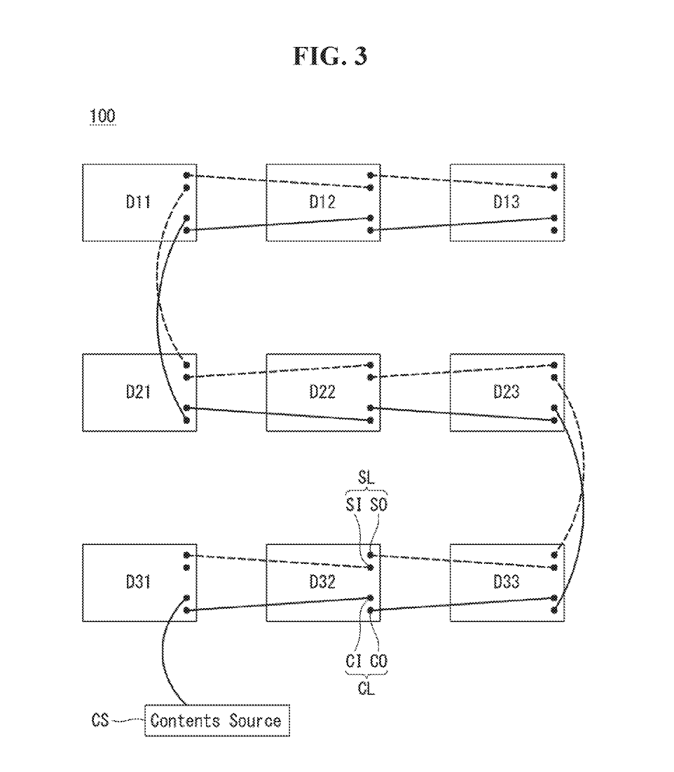

FIG. 3 is a diagram illustrating the wires of the multi-vision of FIG. 1.

As illustrated in FIG. 3, the displays D of the multi-vision 100 may be coupled by content lines CL and signal lines SL. The content lines CL and the signal lines SL may be disposed on the back side of the displays D.

The content line CL may be a line connected to a content source CS and configured to transfer content. The content line CL may include a content-in CI and a content-out CO provided in each of the displays D. For example, this means that the content-in CI of D32 may be connected to the content-out CO of D31 and the content-out CO of D32 may be connected to the content-in CI of D23. The content-ins CI and content-outs CO of the respective displays D are coupled together, so the content lines CL of all the displays D may be connected in a serial structure.

The signal line SL may be a line configured to transfer control signals. The signal line SL may include a signal-in SI and a signal-out CO provided in each of the displays D. For example, this means that the signal-in SI of D32 may be connected to the signal-out SO of D31 and the signal-out SO of D32 may be connected to the signal-in SI of D23. The signal-ins SI and the signal-outs SO of the respective displays D are coupled together, so the signal lines SL of all the displays D may be connected in a serial structure.

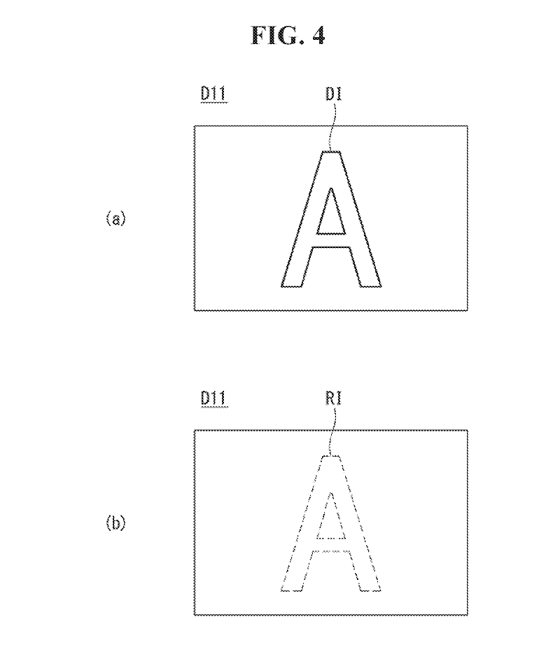

FIGS. 4 to 6 are diagrams illustrating the orbit operation of a display.

As illustrated in FIGS. 4 to 6, each of the displays D may perform an orbit function for preventing a residual image.

As illustrated in FIG. 4(a), an image DI may be displayed on a specific display D. The specific display D is hereinafter indicated by D11, for convenience of understanding. The image DI displayed on D11 may be displayed at the same position for a specific time or higher. For example, this means that the image DI may be displayed at the same position in the same color, like the logo of a broadcasting company that is displayed at a specific location of a screen in a broadcasting screen.

As illustrated in FIG. 4(b), a residual image RI of the image DI may remain in D11 even after the image DI disappears. In particular, such a residual image phenomenon may be generated in self-emissive displays, such as a CRT, a PDP, and an OLED in which each element emits light by itself without using an external light source, such as a backlight unit BLU. The residual image RI may be generated when the specific image DI is fixed at a specific location for a specific time or higher. Furthermore, the residual image RI may be more clearly generated at the boundary part of an image.

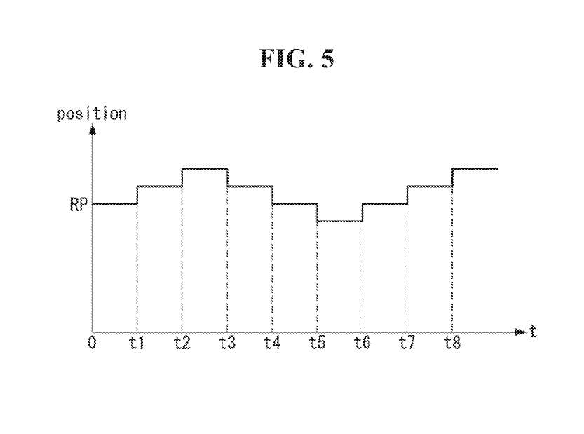

As illustrated in FIG. 5, the position of the image DI displayed on the display D may be changed at a specific time interval in order to prevent a residual image. For example, assuming that the image DI is placed at a reference position RP at a point of time t=0, the position of the image DI may be changed from the reference position RP in one direction at a point of time t1. At a point of time t2, the position of the image DI may be changed from the changed position to another position. That is, the control unit of the displays D may change the position of the image DI at a predetermined specific time interval in order to prevent the residual image RI that is generated because the image DI is placed at the same position for a long time.

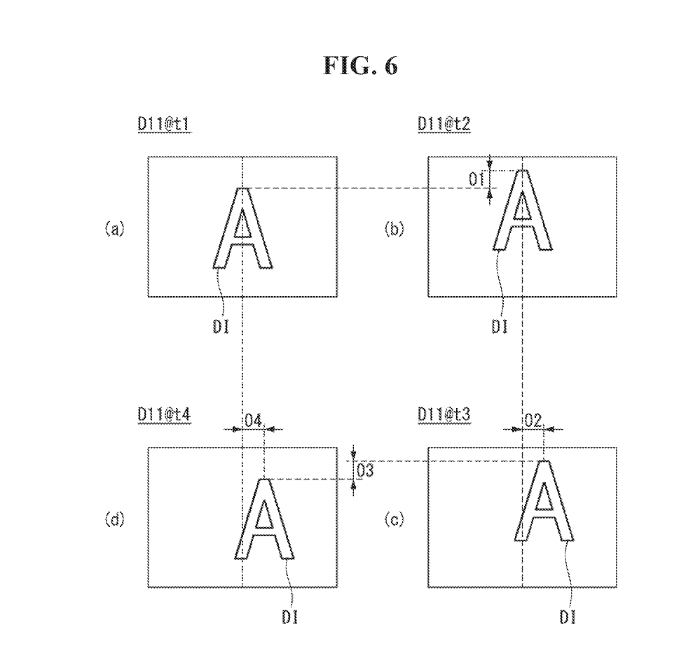

As illustrated in FIG. 6(a), the image DI may be displayed at a specific location of D11 at the point of time t1.

As illustrated in FIG. 6(b), the position of the image DI may be changed at the point of time t2. For example, this means that the position of the image DI may be upward moved by a first offset O1. The offset by which the position of the image DI has been changed may be anterior or posterior to 5 pixels.

As illustrated in FIG. 6(c), the position of the image DI may be changed again at a point of time t3. For example, this means that the position of the image DI may be moved to the right by a second offset O2.

As illustrated in FIG. 6(d), the position of the image DI may be changed again at a point of time t4. For example, this means that the position of the image DI may be downward moved by a third offset O3. After a specific time elapses, the position of the image DI may be moved to the left by a fourth offset O4. That is, this means that the position of the image DI may be moved up and down and left and right at a specific interval and then returned to its original position after several times of movements. If the image DI is moved at a specific time interval, a possibility that the residual image RI may occur may be relatively small. Such a point may be more clearly understood in that a residual image may more strongly appear at the boundary part of the image DI. That is, this means that the generation of the residual image RI can be suppressed because the boundary of the image DI can be moved by moving the image DI by several pixels although the image DI is not greatly moved.

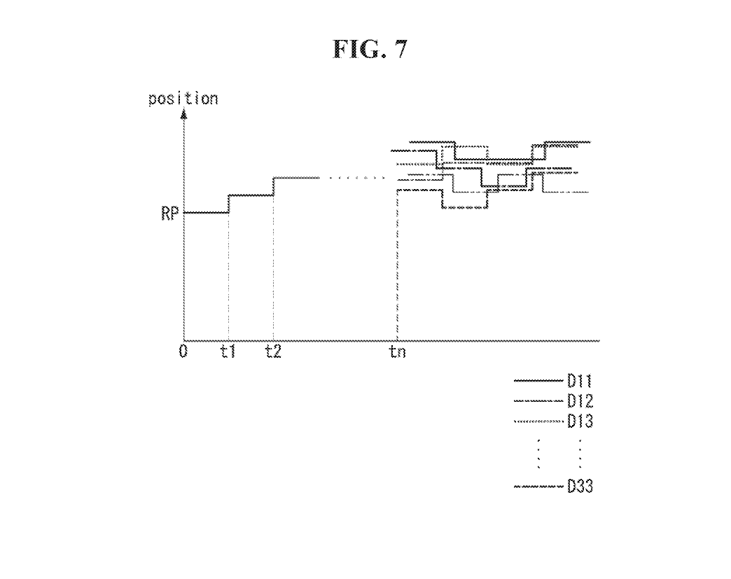

FIGS. 7 to 9 are diagrams illustrating an example of the orbit operation of the multi-vision.

As illustrated in FIGS. 7 to 9, the orbit operation of the multi-vision 100 may be different from that of a single display D. That is, this means that an orbit operation different from that of a single display D needs to be executed in view of the characteristics of the multi-vision 100 on which content is spit and enlarged.

As illustrated in FIG. 7, the multi-vision 100 may perform the orbit operation in order to prevent a residual image. An image may be displayed at the reference position RP of the multi-vision 100 at a point of time t=0. For example, this means that enlarged and spit images may be displayed on D11 to D33.

A timer may be embedded in each of D11 to D33. The timers embedded in D11 to D33 may measure respective predetermined specific time times independently. A first orbit operation may be performed at a point of time t1 after a specific time from the point of time t=0 in accordance with the timer embedded in each of D11 to D33.

A specific number of orbit operations after the first orbit operation may be simultaneously performed as if the orbit operations have been synchronized in accordance with the operations of the embedded timers. That is, this means that although the displays D have not been synchronized, the same effect as that in which orbit operations are performed substantially at the same point of time until specific points of time after the point of time t=0, such as t1, t2, and t3, in accordance with the times embedded in the displays D.

A point of time at which the orbit function is executed by each of the displays D may differ over time. A difference in the point of time at which the orbit function is executed may be generated due to a fine error of the timer embedded in each of the displays D. As described above, the orbit of each of the displays D may be performed at a specific interval based on the embedded timer. In this case, the timer may have a fine error of below decimal point.

If the orbit function is executed at a specific interval, errors may be accumulated, which may become a difference that may be detected by a person. Accordingly, although the orbit functions of the respective D11 to D33 have been simultaneously performed at the point of time t=0, at a point of time t=n, the orbit functions of D11 to D33 are performed in different directions at different points of time. For example, at the point of time t=n, D11 may perform a 100-th orbit function, whereas D12 may be ready to perform a 98-th orbit function.

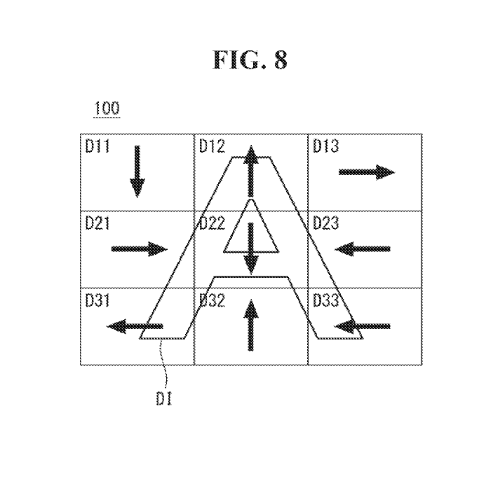

As illustrated in FIG. 8, the multi-vision 100 may have displayed the image DI. If the displays D forming the multi-vision 100 perform the orbit functions based on the respective timers, the orbits of the displays D may be performed in different directions at different points of time. For example, D11 may perform an orbit operation downward, D12 may perform an orbit operation upward, and D13 may perform an orbit operation to the right. If the orbit points of time and/or directions of the displays D are different, a displayed image DI may be distorted.

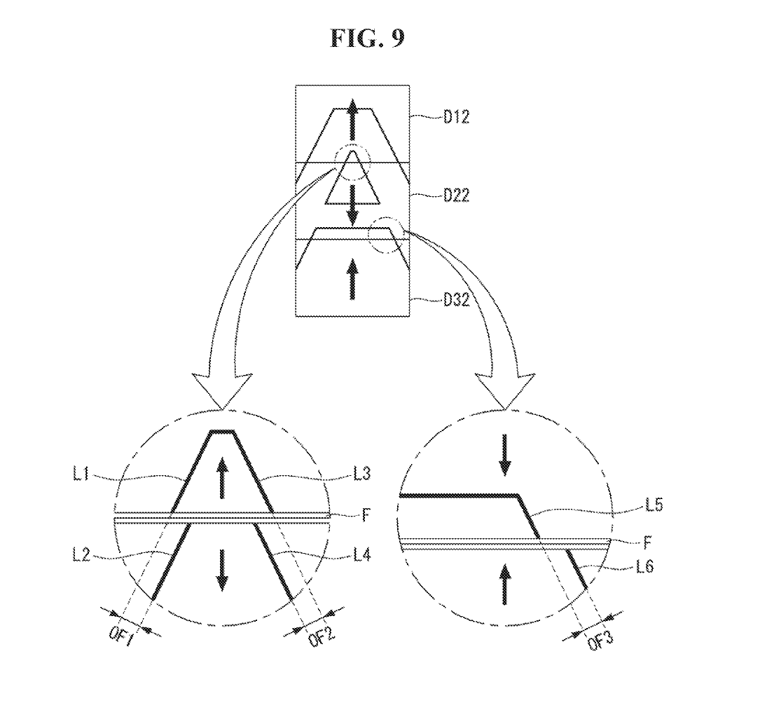

As illustrated in FIG. 9, at a specific point of time, D12 may perform an orbit operation upward, D22 may perform an orbit operation downward, and D32 may perform an orbit operation upward.

A distortion may be generated in an image between D12 and D22 because D12 and D22 perform the orbit operations in different directions. For example, first and second distortions OF1 and OF2 may be generated in an outline L1, L3 displayed on D12, and an outline L2, L4 displayed on D22. That is, this means that a discontinuous point may be generated between an image displayed on D12 and an image displayed on D22 because the image displayed on D12 is upward moved and the image displayed on D22 is downward moved.

A distortion may also be generated in an image between D22 and D32 because D22 and D32 perform the orbit operations in different directions. For example, this means that a third distortion OF3 may be generated in an outline L5 displayed on D22 and an outline L6 displayed on D32.

A distortion attributable to different orbit operations may be generated in each of the displays D. Accordingly, a user who views an image may detect the distortion of the image. Such a point may be a problem unique to the multi-vision 100 that is not generated when an image is viewed using only a single display D.

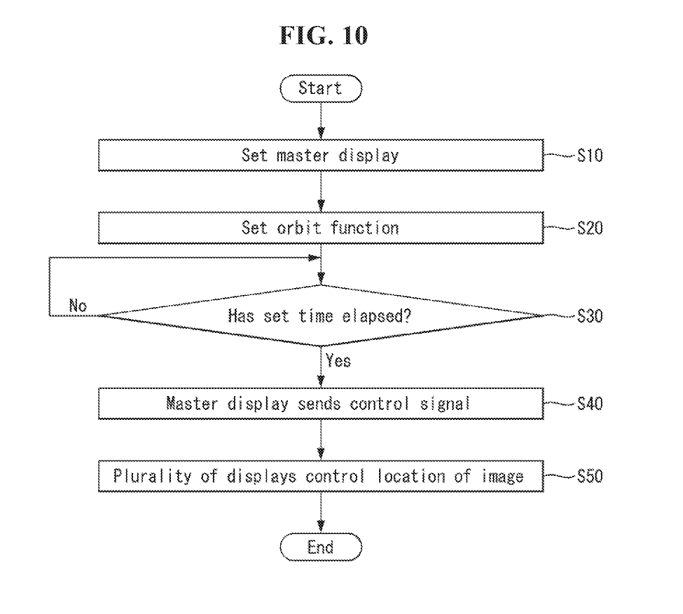

FIG. 10 is a flowchart illustrating an operational process of the multi-vision 100 of FIG. 1.

As illustrated in FIG. 10, the multi-vision 100 according to an embodiment of the present invention may set a master display at step S10.

The master display may be a display D configured to generate a control signal. The control signal may be a signal that starts an orbit function. For example, the master display may generate a control signal that enables the orbit function to be executed at a specific time interval. When the master display generates the control signal at a specific interval and sends the generated control signal to other displays, all the displays D may substantially simultaneously perform their orbit functions.

The master display may be set based on a user's selection. For example, this means that a specific one of the displays D may be set as the master display. The master display may be set through the selection menu of a specific display D. For example, when a unique ID assigned to each of the displays D is selected, a display D corresponding to the ID may be set as the master display.

An orbit function may be set at step S20.

The orbit function may be selectively activated in response to a user's selection or in response to the control signal of the control unit or both.

When a set time elapses after the orbit function was set at step S30, the master display may send the control signal at step S40, and the plurality of displays may control the locations of their images at step S50.

The master display may send the control signal at a predetermined specific time interval.

When the master display sends the control signal, the plurality of displays D may control the locations of the images in response to the control signal. For example, this means that each display may move each image to a reference position, that is, a specific point, at a point of time at which the control signal has been received. The location of the image may be controlled while the orbit function is executed. Accordingly, control of the location of the image is hereinafter described as one of orbit functions, for convenience of understanding.

The orbit cycles and/or locations of the multi-vision 100 may be synchronized based on a specific point of time at which the master display sends the control signal. When the orbit cycles and/or locations of the multi-vision 100 are synchronized, the distortion of an image that may be felt by a user can be prevented.

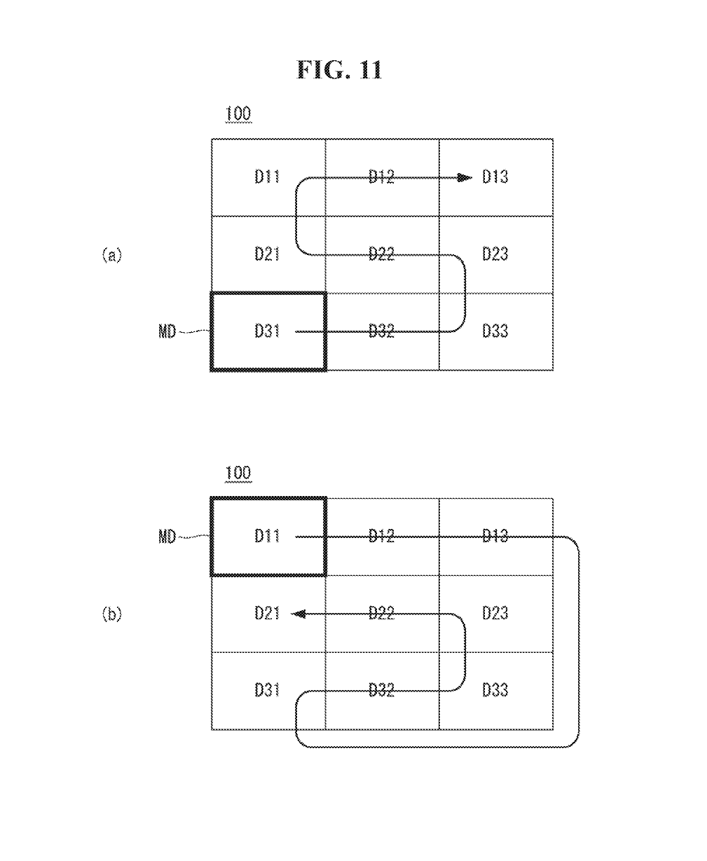

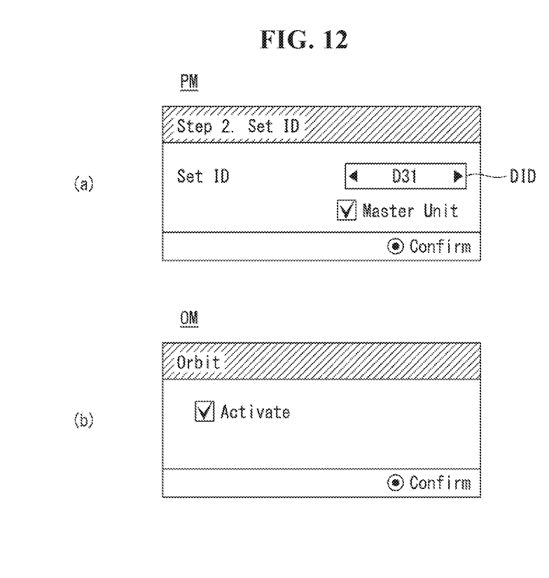

FIGS. 11 and 12 are diagrams illustrating a process of setting the master display of the multi-vision in the operational process of FIG. 10.

As illustrated in FIGS. 11 and 12, the multi-vision 100 according to an embodiment of the present invention may determine whether or not to activate a master display MD and an orbit function. A user can conveniently maintain and manage the multi-vision 100 because the master display MD and the orbit function can be set.

As illustrated in FIG. 11(a), D31 of the multi-vision 100 may be set as a master display MD. D31 set as the master display MD may send a specific control signal. The control signal may be transferred along the signal lines (SL of FIG. 3). For example, the control signal may be transferred along the signal lines (SL of FIG. 3) in one direction. That is, the control signal transmitted by D31, that is, the master display MD, may be sequentially transferred to D32, D33, and D23 along a path that connects the signal lines (SL of FIG. 3).

As illustrated in FIG. 11(b), D11 may be set as a master display MD. If D11 is set as the master display MD, a control signal may be sequentially transferred to D12, D13, and D31 along the signal lines (SL of FIG. 3). If a signal line (SL of FIG. 3) is changed, sequence of a signal that is transferred may be changed. In this case, the master display MD may be set and/or changed by a user and/or in response to the setting of the control unit if the master display MD has only to be placed on a signal line not a display D at a point at which a signal line (SL of FIG. 3) is physically started.

As illustrated in FIG. 12(a), a master pop-up PM for setting a master display MD may be displayed. A user may select the device ID DID of a display D that belongs to the displays D forming the multi-vision 100 and that is desired to be set as a master display MD. A display D corresponding to the selected device ID DID may be set as the master display MD.

As illustrated in FIG. 12(b), an orbit pop-up OM for selecting whether or not to activate an orbit function may be displayed. A user may select a button for activating or deactivating the orbit function of the multi-vision 100 or a specific display D.

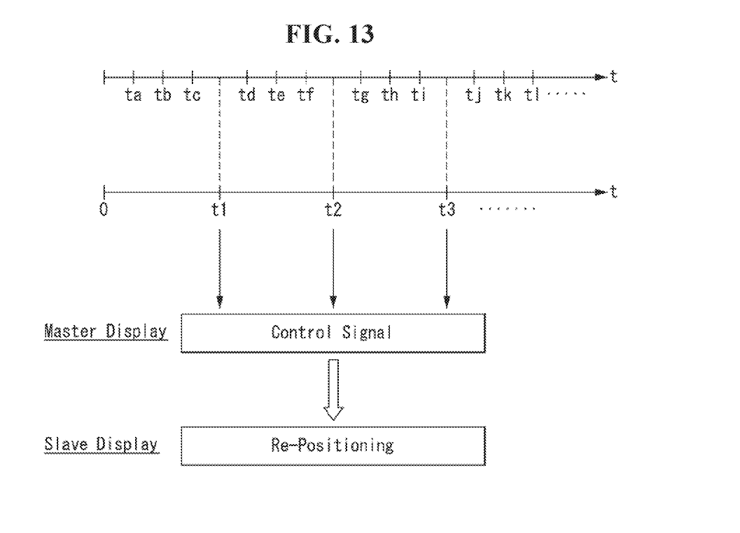

FIGS. 13 to 15 are diagrams illustrating an operational process of the multi-vision in FIG. 10.

As illustrated in FIGS. 13 to 15, the multi-vision 100 according to an embodiment of the present invention may obtain a control signal generated by a master display MD and perform synchronized orbit functions.

As illustrated in FIG. 13, points of time t1, t2, and t3, that is, predetermined specific time intervals, may be present.

A master display may generate a control signal at the points of time t1, t2, and t3, that is, specific points of time. The control signal generated by the master display may be transferred to a slave display.

The points of time t1, t2, and t3, that is, specific points of time, may be point of times at which each of the displays D has performed its orbit functions several times. For example, each of D11 to D33 may have performed the orbit function at points of time ta, tb, and tc based on each timer between the points of time t=0 and t1. That is, this means that a point of time at which the master display generates the control signal may be after the slave display has performed the orbit function several times. Each of the displays D has its timer. A significant error in executing the orbit functions within a specific number of times may not be generated based on the time of the timer. Accordingly, although each of the displays D performs its orbit functions up to the points of time at which ta, tb, and tc, the distortion of an image that may be felt by a user may be small.

In response to the control signal, the slave display may again set the position of an image that is being displayed. That is, this means that the plurality of displays D forming the multi-vision 100 may perform their image resetting functions for a specific point at a specific point of time. Accordingly, the distortion of an image attributable to the execution of the orbit function of each display D can be minimized and prevented.

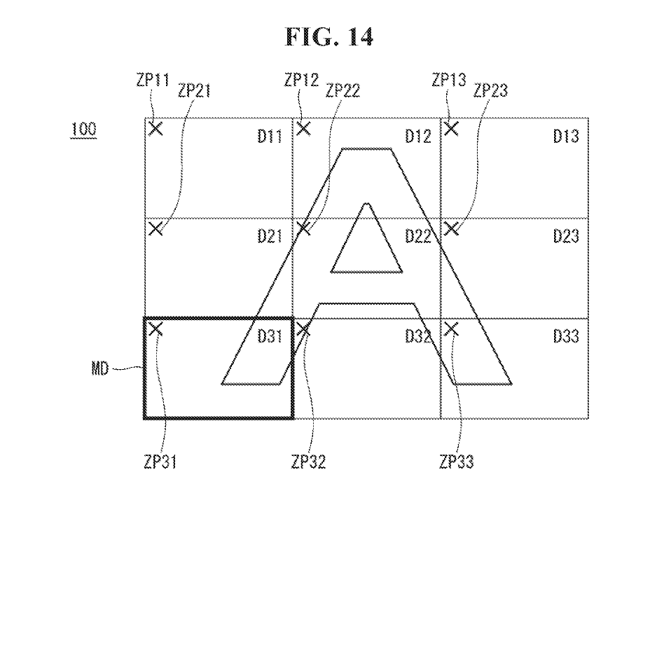

As illustrated in FIG. 14, the multi-vision 100 may perform the resetting of image positions in response to a control signal generated by a master display. For example, a master display MD may send the control signal at a specific point of time. The control signal transmitted by D31, that is, the master display MD, may be a zero positioning signal.

In response to the zero positioning signal, the displays D, that is, slave displays, may move their images to respective positions ZP11 to ZP33, that is, a reference position. That is, this means that the images move to a first display position at a specific point of time. Accordingly, there is an advantage in that the images are rearranged at a specific point of time. Since the images are rearranged, the distortion of images that may have occurred due to previous orbit functions can be naturally solved.

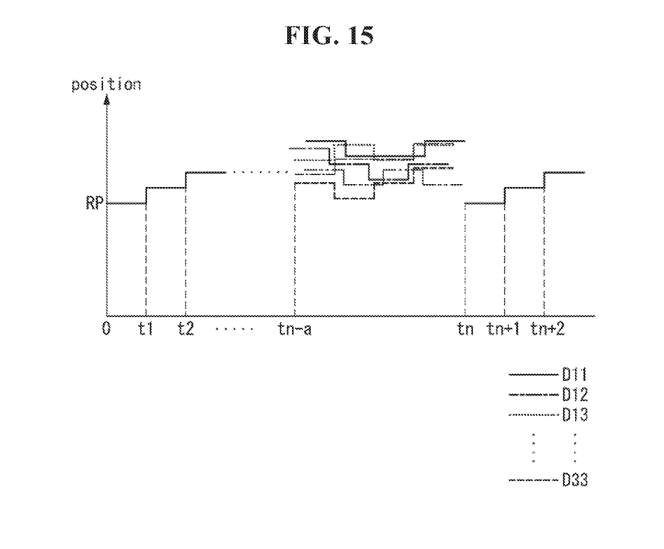

As illustrated in FIG. 15, the displays D may perform their orbit functions at points of time t1 and t2. When a point of time tn-a is reached, the distortion of images may occur due to orbit functions performed by the displays D.

A master display may generate a control signal at a point of time tn.

In response to the control signal from the master display, the displays D may rearrange the locations of their images. Accordingly, the distortion of the images that may have previously occurred can be fully solved at the point of time tn. Orbit functions may be performed again based on the timers of the displays D from a point of time tn+1.

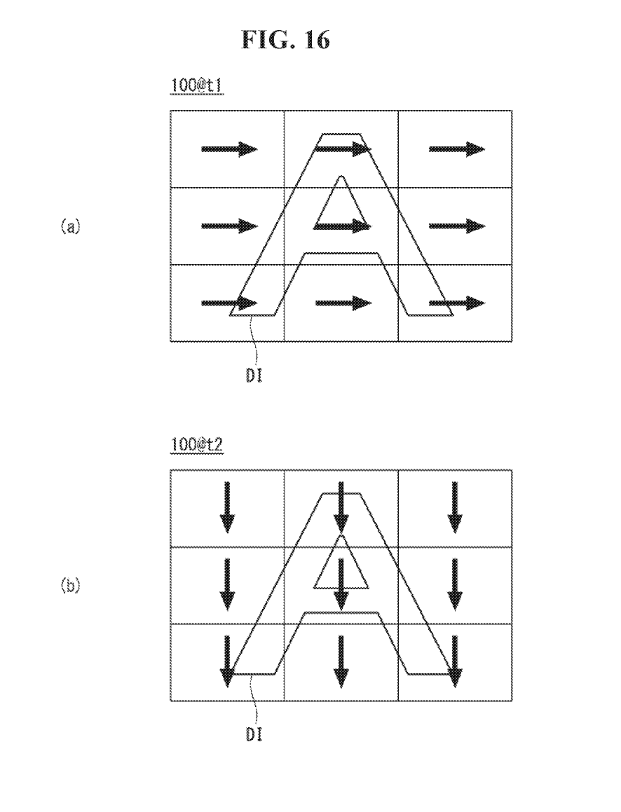

FIG. 16 is a diagram illustrating an operation of the multi-vision according to another embodiment of the present invention.

As illustrated in FIG. 16, the multi-vision 100 according to another embodiment of the present invention may determine a point of time at which and/or a direction along which a master display will perform an orbit function.

As illustrated in FIG. 16(a), the master display may generate a control signal at a point of time t1. The control signal generated by the master display may include the execution of orbit functions, the direction along which images will be moved by the orbit functions and/or the number of pixels to be moved by the orbit function. For example, the control signal at the point of time t1 may include that an image is moved to the right by 5 pixels at a point of time at which the control signal is generated.

In response to the control signal from the master display, the displays D may uniformly move an image DI to the right by 5 pixels at a time. Accordingly, the distortion of an image may not be generated in the entire multi-vision 100.

As illustrated in FIG. 16(b), the master display may generate the control signal at a point of time t2. For example, this means that the master display may generate a control signal that enables the image DI to be downward moved by 3 pixels at the point of time t2. In response to the control signal, the displays D may change the location of the image.

The control signal of the master display may replace an orbit function prior to its execution based on the timer embedded in each of the displays D. That is, this means that an orbit function performed by each of the displays D may be deactivated and a new orbit function may be activated in response to a signal from the master display.

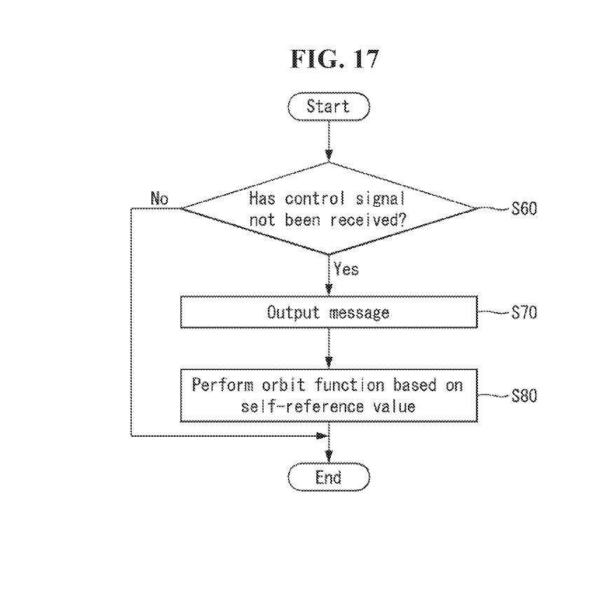

FIG. 17 is a flowchart illustrating an operational process of the multi-vision according to yet another embodiment of the present invention.

As illustrated in FIG. 17, the multi-vision 100 according to yet another embodiment of the present invention may output a message at step S70 when a control signal is not received at step S60.

A master display may periodically generate a control signal in the state in which an orbit function has been activated. In this case, the reception of the control signal from the master display may be stopped due to the abnormality of the master display and/or a signal line.

If the control signal is not received for a specific time or higher, an image displayed on the multi-vision 100 may be distorted. In this case, the control unit may display a message, reading that the control signal is not received, on at least one display D.

An orbit function based on a self-reference value may be performed at step S80.

Each of the displays D may perform an orbit function based on its criterion. If an orbit function is not performed, a residual image phenomenon may be generated as described above. Accordingly, each of the displays D may continue to perform an orbit function based on its embedded timer.

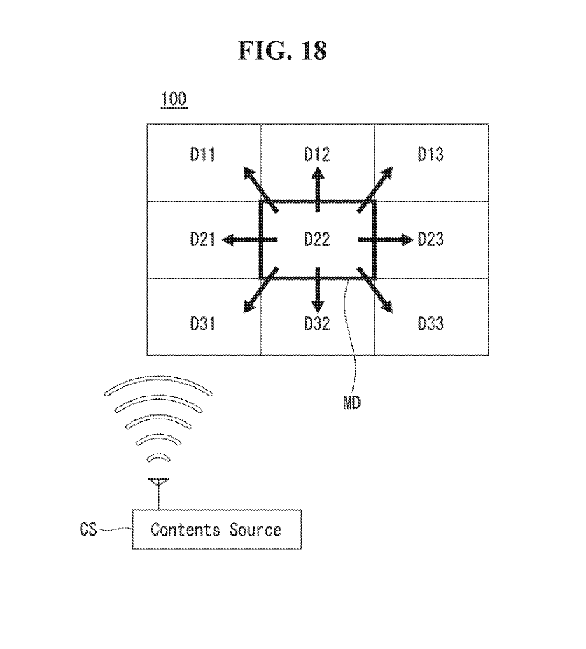

FIG. 18 is a diagram illustrating an operation of the multi-vision according to yet another embodiment of the present invention.

As illustrated in FIG. 18, the multi-vision 100 according to yet another embodiment of the present invention may send a control signal through wireless communication.

The displays D that form the multi-vision 100 may include a wireless communication module. That is, this means that the displays D may wirelessly exchange data with a content source CS.

A master display MD may wirelessly send control signals. The control signals of the master display MD may be substantially simultaneously transferred to other displays in parallel. That is, this means that the control signals are not sequentially/serially received through the signal lines (SL of FIG. 3), but the control signals may be wirelessly received in parallel. The configuration of complicated lines for connecting the displays D may be not necessary because data is wirelessly transmitted and received. Furthermore, time delay attributable to the sequential transfer of signals can be minimized because the signals can be transferred from a master display to other displays in parallel.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1-16. (canceled)

17. A multi-vision display, comprising:
a plurality of displays including a master display and slave displays in a matrix form; and
a controller configured to:
display image portions on the plurality of displays to form a display image, and
shift the image portions on the plurality of displays in a synchronized manner a predetermined number of times to perform an orbit function and prevent a residual image on the plurality of displays.

18. The multi-vision display of claim 17, wherein the controller is further configured to shift the image portions in response to a control signal received from the master display.

19. The multi-vision display of claim 17, wherein the controller is further configured to re-position the image portions to an initial position in response to a control signal received from the master display.

20. The multi-vision display of claim 19, wherein the predetermined number of times the image portions are shifted is greater than 1.

21. The multi-vision display of claim 20, wherein the controller is further configured to transmit the control signal at intervals greater than then predetermined number of times.

22. The multi-vision display of claim 21, wherein the predetermined number of times is at least three times, and the controller transmits the control signal to re-position the image portions after the predetermined number of times.

23. The multi-vision display of claim 17, wherein the image portions are shifted in a same direction on the plurality of displays in the synchronized manner to perform the orbit function.

24. The multi-vision display of claim 23, wherein the same direction includes one of a right direction, a left direction, an upward direction and a downward direction.

25. The multi-vision display of claim 17, wherein at least one signal line connects the master display to the slave displays in a serial manner.

26. The multi-vision display of claim 25, wherein the plurality of displays include one master display and eight slave displays in the matrix form.

27. The multi-vision display of claim 26, wherein the at least one signal line connects the master display to a first slave display, connects the first slave display to a second slave display, connects the second slave display to a third slave display, connects the third slave display to a fourth slave display, connects the fourth slave display to a fifth slave display, connects the fifth slave display to a sixth slave display, connects the sixth slave display to a seventh slave display, and connects the seventh slave display to an eight slave display.

28. The multi-vision display of claim 17, wherein the controller is further configured to display a menu for setting the orbit function and for selecting a particular display as the master display.

29. The multi-vision display of claim 18, wherein the controller is further configured to display a message if the control signal is not received from the master display within a predetermined amount of time.

30. The multi-vision display of claim 17, wherein the master display comprises a wireless communication processor configured to send and receive image information for displaying the image portions to form the display image from a contents source.

31. A method of controlling a multi-vision display, the method comprising:
displaying image portions on a plurality of displays including a master display and slave displays in a matrix form to form a display image; and
shifting, via a controller, the image portions on the plurality of displays in a synchronized manner a predetermined number of times to perform an orbit function and prevent a residual image on the plurality of displays.

32. The method of claim 31, further comprising:
shifting the image portions in response to a control signal received from the master display.

33. The method of claim 31, further comprising:
re-positioning the image portions to an initial position in response to a control signal received from the master display.

34. The method of claim 33, wherein the predetermined number of times the image portions are shifted is greater than 1.

35. The method of claim 34, further comprising:
transmitting the control signal at intervals greater than then predetermined number of times.

36. The multi-vision display of claim 35, wherein the predetermined number of times is at least three times, and the method further comprises transmiting the control signal to re-position the image portions after the predetermined number of times.
